(19) United States
(12) Patent Application Publication
(10) Pub. No.: US 2004/0138976 A1
(43) Pub. Date: Jul. 15, 2004

(54) Notes receivable management system and method

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/744,637

(22) Filed: Dec. 22, 2003

(30) Foreign Application Priority Data
Dec. 20, 2002 (TW) 91136962

(51) Int. Cl. G06F 17/60

(52) U.S. Cl. 705/35

(57) ABSTRACT

A notes receivable management system includes a number of client computers (10), an application server (12), a database (14), and a network (11) connects the client computers with the application server, a connection connects the database with the application server. The client computers provide interfaces for users to maintain information. The application server includes function modules for receiving input information, processing the information, and returning results. In particular, the application server includes an authorization control module, an information maintaining module, a notes storing module, a discounting module, a pledging module, an entrusting collection module, a notes changing module, a cashing module, a bank deposit settling module, and a report generating module. The database is used for storing information on notes receivable. A related method is also disclosed.

### BACKGROUND OF THE INVENTION

1. Field of the Invention

The present invention relates to a computer-based notes receivable management system and method, and particularly to a notes receivable management system and method for managing notes receivable circulation within an enterprise.

2. Description of Related Art

Efficient notes receivable management is vital for vast multinational manufacturing corporations. Whether a note receivable can be cashed is important, because the note receivable might become valueless at some point in time. If managers cannot manage notes receivable efficiently, bad accounts occur and can bring financial hardship to the enterprise. Operations involving notes receivable typically include drawing, discounting, pledging, changing, modifying, entrusting for collection, cashing, and so on. There is vast range of notes receivable management software available in the marketplace. However, most of these programs simply speed up operations involving notes receivable, without adequately providing useful functions for efficiently managing operations involving notes receivable.

Computer-aided notes receivable management systems are disclosed in a number of patents. U.S. Pat. No. 5,121,945 issued on Jun. 16, 1992 and entitled “Financial Data Processing System” discloses methods (and systems) for effecting the accounting functions of debiting and crediting a bank's account records, a payer's bank account records and a corporation's accounts receivable records with their customer's payments. The methods are based upon the combination of data from two or more sources to prepare an integrated document. The methods concentrate on dealing with the bank's account records. However, the methods do not adequately provide for management of notes receivable.

It is necessary to provide an improved notes receivable management system and method.

### SUMMARY OF THE INVENTION

An object of the present invention is to provide a notes receivable management system for controlling all the notes receivable of an enterprise.

Another object of the present invention is to provide a notes receivable management method for controlling all the notes receivable of an enterprise.

To achieve the first above-mentioned objective, the present invention provides a notes receivable management system. A preferred embodiment of the system comprises an application server, a database, a plurality of client computers, and a network and a connection connecting the apparatuses. The client computers provide interfaces for users to maintain information. The application server comprises an authorization control module, an information maintaining module, a notes storing module, a discounting module, a pledging module, an entrusting collection module, a notes changing module, a cashing module, a bank deposit settling module, and a report generating module. The authorization control module is used for defining and controlling operational rights and scope for each user; the information maintaining module is used for adding, modifying, searching, and deleting basic information; the notes storing module is used for storing information on notes receivable; the discounting module is used for computing discount value and discount interest; the pledging module is used for operating notes pledging; the entrusting collection module is used for operating notes collection; the notes changing module is used for operating notes changing; the cashing module is used for operating cash paying of the note after the due date; the bank deposit settling module is used for transferring corresponding value of the note receivable being discounted or cashed to deposit account, and for automatically settling the bank deposit; and the report generating module is used for generating reports according to the users requirements. The database is used for storing information on notes receivable.

To achieve the second above-mentioned objective, the present invention provides a preferred method for notes receivable management. The method comprises the following steps: (a) storing the information on a note receivable in a database; (b) determining whether the note needs to be discounted, if it needs to be discounted, discounting the note; (c) determining whether the note needs to be pledged if it does not need to be discounted, and if it needs to be pledged, pledging the note; (d) determining whether the note needs to be entrusted for collection if it does not need to be pledged, and if it needs to be entrusted for collection, entrusting the note for collection; (e) determining whether the note needs to be changed if it does not need to be entrusted for collection, and if it needs to be changed, changing the note; (f) cashing the note if it does not need to be changed; and (g) settling a bank deposit.

Other objects, advantages and novel features of the present invention will be drawn from the following detailed description of preferred embodiments of the present invention with the attached drawings, in which:

### BRIEF DESCRIPTION OF THE DRAWINGS

FIG. 1 shows hardware infrastructure of a system for notes receivable management in accordance with the preferred embodiment of the present invention;

FIG. 2 is a schematic diagram of function modules of the application server of FIG. 1;

FIG. 3 is a main flowchart of the preferred method for operating the system of the present invention; and

FIG. 4 is a flowchart of details of a step of FIG. 3, namely changing a note receivable.

### DETAILED DESCRIPTION OF THE INVENTION

Reference will now be made to the drawing figures to describe the present invention in detail.

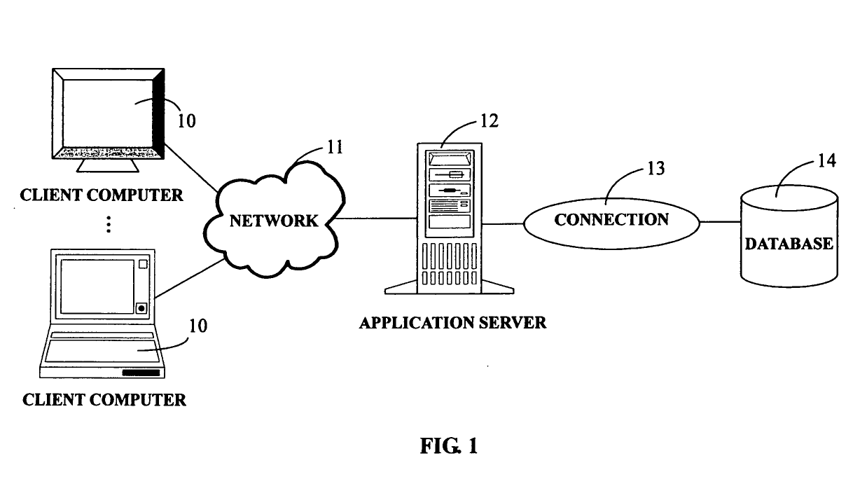

FIG. 1 shows hardware infrastructure of a system for notes receivable management (hereinafter, “the system”) in accordance with the preferred embodiment of the present invention. The system comprises a plurality of client computers 10, an application server 12, and a database 14. The client computers 10 are connected with the application server 12 via a network 11, and the database 14 is connected with the application server 12 via a connection 13. The network 11 can be the Internet, an intranet, or another suitable means of electronic communication. The connection 13 is a kind of database connection, which can be an Open Database Connectivity (ODBC), a Java Database Connectivity (JDBC) or another suitable kind of connectivity. The client computers 10 are located in various different places of an organization employing the system, and provide interfaces for users to maintain information. The application server 12 comprises function modules for receiving input information, processing the information, and returning results. The database 14 is used for storing information on notes receivable. The notes receivable include merchant's draft receivables.

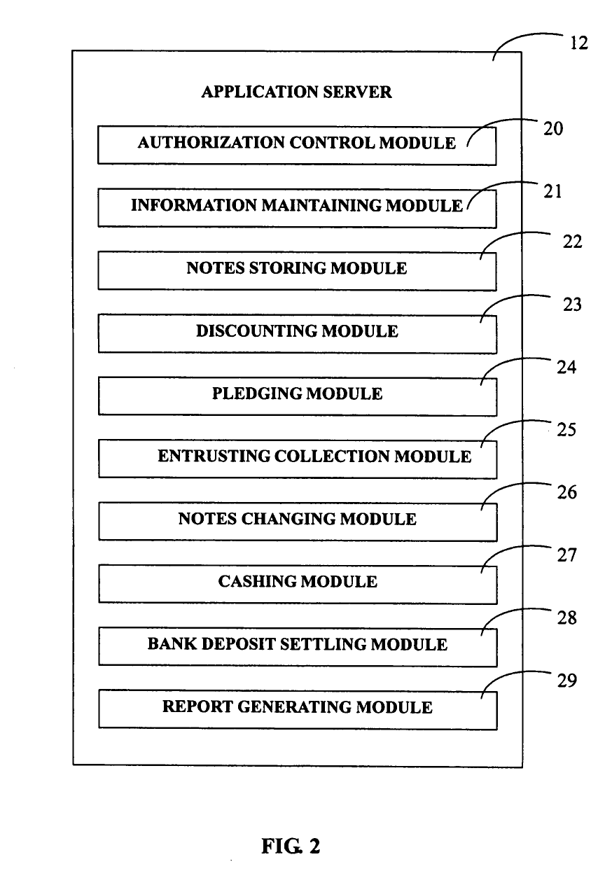

FIG. 2 is a schematic diagram of function modules of the application server 12. The application server 12 comprises an authorization control module 20, an information maintaining module 21, a notes storing module 22, a discounting module 23, a pledging module 24, an entrusting collection module 25, a notes changing module 26, a cashing module 27, a bank deposit setting module 28, and a report generating module 29.

The authorization control module 20 is for defining and controlling operational rights and scope for each user.

The information maintaining module 21 is for adding, modifying, searching, and deleting basic information. The basic information comprises information on accounts, information on preset trade entries, information on report templates, reasons for dishonored notes, and so on.

The notes storing module 22 is for storing information on notes receivable in the database 14. The information on notes receivable is input by a user via the client computer 10. Each note receivable comprises a status field. If the information on the note receivable has been stored, the status field of the note receivable is marked as “stored.” The system can automatically generate corresponding accounting entries according to the preset trade entries and any particular operation involving the note receivable.

The discounting module 23 is for operating note discounts. The system can automatically compute discount values and discount interest according to discount dates and discount rates input by the user. A note that is discounted is marked accordingly. The system can automatically generate corresponding accounting entries according to the preset trade entries and the above-described operation of note discounting.

The pledging module 24 is for operating note pledgings. The system can store a pledged bank and a pledged date of a note input by the user in the database 14. The note pledged is marked accordingly. The system can automatically generate corresponding accounting entries according to the preset trade entries and the above-described operation of note pledging.

The entrusting collection module 25 is for operating note collections. The system can store a remitting bank and a collection date of a note input by the user in the database 14. The note entrusted for collection is marked as “entrusted.” The system can automatically generate corresponding accounting entries according to the preset trade entries and the above-described operation of note collecting.

The notes changing module 26 is for operating note changes. Changing operations comprise note dishonoring and note modification. The system can display all the modifiable fields of each note. The modifiable fields comprise a number of the note, a drawer bank, an account number, a due date, and so on. The modified note is stored in the database 14. If the note is dishonored, certain measures can be adopted. The measures comprise the operations of drawing a new note, collecting cash instead of the dishonored note, changing the note to an account receivable, and so on. If the operation is drawing a new note, the system stores the new note in the database 14. If the operation is to collect cash, the system settles the bank deposit. If the operation is to change the note to an account receivable, the system carries the entry from the note receivable to a corresponding account receivable. The system can automatically generate corresponding accounting entries according to the preset trade entries and any of the above-described operations.

The cashing module 27 is for operating cashing of notes after their respective due dates. The system can store the paying date of each note input by the user in the database 14. The note being cashed is marked as “cashed.” The system can automatically generate corresponding accounting entries according to the preset trade entries and the above-described operation of note cashing.

The bank deposit settling module 28 is for transferring corresponding values of the notes receivable being discounted or cashed to a deposit account. The bank deposit settling module 28 is also for automatically settling the bank deposit. The system can automatically generate corresponding accounting entries according to the preset trade entries and the above-described operations of transferring and settling.

The report generating module 29 is for generating reports according to user requirements and the preset templates. The reports comprise a report on detailed information on notes receivable, a report on notes receivable that are pledged, a report on notes receivable that are discounted, a report on notes receivable that are cashed, and so on.

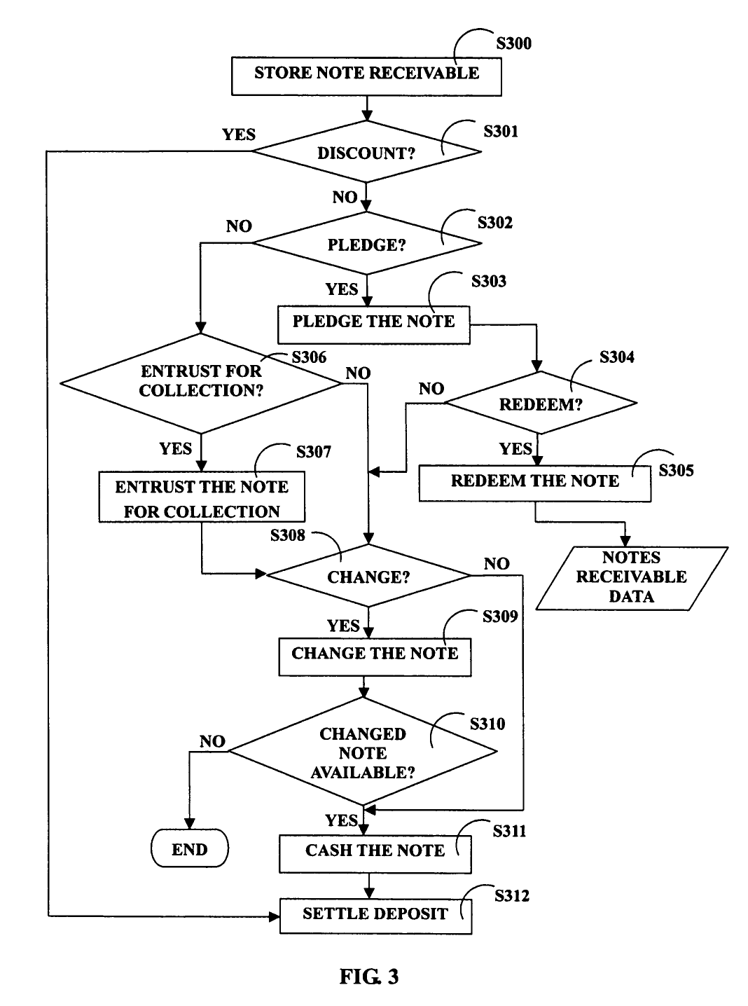

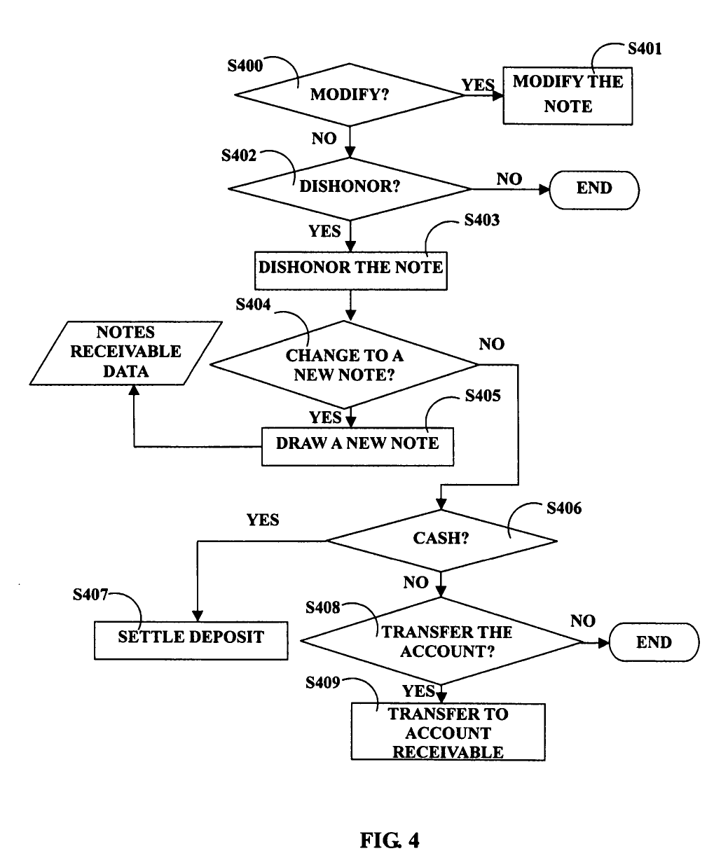

FIG. 3 is a main flowchart of the preferred method for operating the system of the present invention. In step S300, a user inputs information on a note received via the user interface provided by the corresponding client computer 10. The system stores the information on the note received in the database 14 as the notes receivable data. In step S301, the user determines whether the note needs to be discounted. If the note needs to be discounted, the procedure goes directly to step S312 described below. If the note does not need to be discounted, in step S302, the user determines whether the note needs to be pledged. If the note needs to be pledged, in step S303, the system pledges the note. In step S304, the user determines whether the pledged note needs to be redeemed. If the pledged note does not need to be redeemed, the procedure goes directly to step S308 described below. If the pledged note needs to be redeemed, in step S305, the system redeems the pledged note, and the information on the redeemed note is stored in the database 14 as notes receivable data. If the note does not need to be pledged, in step S306, the user determines whether the note needs to be entrusted for collection. If the note does not need to be entrusted for collection, the procedure goes directly to step S308 described below. If the note needs to be entrusted for collection, in step S307, the system entrusts the note for collection. In step S308, the user determines whether the note needs to be changed. If the note does not need to be changed, the procedure goes directly to step S311 described below. If the note needs to be changed, in step S309, the system changes the note. In step S310, the user determines whether the changed note is available. If the changed note is not available, the system ends the procedure. If the changed note is available, in step S311, the system cashes the note. In step S312, the system settles the bank deposit, and the system can generate reports according to the user's requirements. The process of changing the note is described in more detail below with reference to FIG. 4.

FIG. 4 is a flowchart of details of step S309 of FIG. 3, namely changing the note receivable. In step S400, the user determines whether any detail of the note needs to be modified. If any detail of the note needs to be modified, in step S401, the user modifies the detail of the note. The system can display all the modifiable fields of the note. The modifiable fields comprise the number of the note, the drawer bank, the account number, the due date, and so on. If no detail of the note needs to be modified, in step S402, the user determines whether the note needs to be dishonored. If the note does not need to be dishonored, the system ends the procedure. If the note needs to be dishonored, in step S403, the system selects one of preset reasons for dishonoring the note. In step S404, the user determines whether the note needs to be changed to a new note. If the note does not need to be changed to a new note, the procedure goes to step S406 described below. If the note needs to be changed to a new note, in step S405, the user draws a new note, and the system stores the information on the new note in the database 14 as the note receivable data. In step S406, the user determines whether the note can be cashed. If the note can be cashed, in step S407, the system settles the bank deposit after cashing the note, and the system can generate reports according to the user's requirements. If the note cannot be cashed, in step S408, the user determines whether the account of the note needs to be transferred. If the account of the note does not need to be transferred, the system ends the procedure. If the account of the note needs to be transferred, in step S409, the system transfers the account of the note from notes receivable to accounts receivable.

In general, the system and method of the present invention may take forms other than what is described above. While the preferred embodiment and method for carrying out the invention have been described in detail, those familiar with the art to which the invention relates will recognize various alternative designs and embodiments for practicing the invention. These alternative embodiments are within the scope of the present invention. The scope of the present invention is defined by the claims appended hereto and allowable equivalents thereof.

What is claimed is:

1. A notes receivable management system comprising an application server, a database, a plurality of client computers, and a network and a connection connecting said apparatuses, wherein:
the plurality of client computers provide interfaces for users to maintain information;
the application server comprises an information maintaining module, a notes storing module, a discounting module, a pledging module, an entrusting collection module, a notes changing module, a cashing module, and a bank deposit settling module, wherein:
the information maintaining module is used for adding, modifying, searching, and deleting basic information;
the notes storing module is used for storing information on notes receivable;
the discounting module is used for computing discount values and discount interest;
the pledging module is used for operating notes pledging;
the entrusting collection module is used for operating notes collection;
the notes changing module is used for operating notes changing;
the cashing module is used for operating cashing of notes after their respective due dates; and
the bank deposit settling module is used for transferring corresponding values of notes receivable being discounted or cashed to a deposit account, and for automatically settling the bank deposit; and
the database is used for storing information on notes receivable.

2. The notes receivable management system as described in claim 1, wherein the application server further comprises an authorization control module for defining and controlling operational rights and scope for each user.

3. The notes receivable management system as described in claim 1, wherein the application server further comprises a report generating module for generating reports according to user requirements.

4. A notes receivable management method comprising the following steps:
storing information on a note receivable in a database;
discounting the note if the note is marked to be discounted;
pledging the note if the note is marked to be pledged;
entrusting the note for collection if the note is marked to be entrusted for collection;
changing the note if the note is marked to be changed;
cashing the note if the note is not marked to be changed; and
settling a bank deposit.

5. The notes receivable management method as described in claim 4, further comprising the step of:
determining whether the changed note is available, and cashing the changed note if it is available.

6. The notes receivable management method as described in claim 4, further comprising the step of:
generating a report according to a user's requirements.

7. The notes receivable management method as described in claim 4, wherein the step of changing the note receivable further comprises the steps of:
determining whether the note needs to be modified;
modifying the note and storing the modified note in the database, if the note needs to be modified;
determining whether the note needs to be dishonored if the note does not need to be modified; and
dishonoring the note if the note needs to be dishonored.

8. The notes receivable management method as described in claim 4, wherein the step of changing the note receivable further comprises the steps of:
determining whether the note needs to be changed to a new note;
drawing a new note if the note needs to be changed to a new note;
determining whether the note can be cashed, if the note does not need to be changed to a new note;
cashing the note if the note can be cashed, and settling the bank deposit;
determining whether the account of the note needs to be transferred, if the note cannot be cashed; and
transferring the account of the note from notes receivable to accounts receivable, if the account of the note needs to be transferred.
